(19) United States
(12) Patent Application Publication
(10) Pub. No.: US 2013/0331020 A1
(43) Pub. Date: Dec. 12, 2013

(54) FAN STRIP OF A VEHICLE SLIDING HEADLINER

(71) Applicants: Stephan Schreiter, Gauting (DE); Richard Sirtl, Issing (DE)

(72) Inventors: Stephan Schreiter, Gauting (DE); Richard Sirtl, Issing (DE)

(73) Assignee: Webasto SE, Stockdorf (DE)

(21) Appl. No.: 13/978,096

(22) PCT Filed: Jan. 3, 2012
(86) PCT No.: PCT/EP2012/000013

§ 371 Date: Aug. 16, 2013

(30) Foreign Application Priority Data
Jan. 10, 2011 (DE) 10 2011 008 216.6

(51) Int. Cl. B60H 1/00

(52) U.S. Cl. CPC B60H 1/00457
USPC 454/136

(57) ABSTRACT

The invention relates to a fan strip of a sliding headliner of a vehicle roof that can be opened, wherein the fan strip has at least one ventilation opening through which an air flow can flow, and wherein according to the invention the fan strip has a device for influencing the air current in the ventilation opening or in an air-current duct associated with the ventilation opening.

The invention relates to a fan strip of a sliding headliner on a vehicle roof that can be opened, whereby the fan strip has at least one ventilation opening through which an air current can flow.

A sliding headliner of a fan roof of a vehicle is known from DE 39 30 054 A1 that has a plurality of slot-shaped air passage openings in its front part through which an air current can flow through. Air guide elements are arranged on the top of the sliding headliner above the air passage openings which guide elements form, together with the air passage openings, air guide ducts. A predetermined flow behavior can be forced on the air current by these air guide elements in order, for example, to minimize flow noises. A ventilation flow from the air guide ducts can be guided on the cover of the fan roof described here, which cover can be lowered on its front edge, from the air guide ducts via the space between the closed sliding headliner and the lowered cover to the front and around the front cover edge and through the slot between the front cover edge and a front edge of a roof section. However, it turned out in practice that flow noises and whistling noises cannot be entirely avoided in the air guide ducts shown.

The invention has the basic problem of creating an initially cited fan strip on a sliding headliner that is improved as regards its flow behavior when air is passing through it.

The problem is solved for the initially cited fan strip in accordance with the invention in that the fan strip has a device for influencing the air current in the at least one ventilation opening or in an air current duct associated with the ventilation opening. The influencing thus takes place in the ventilation opening or in the flow duct of the ventilation opening and not subsequently in or on additional flow guide devices that are arranged after the ventilation opening or openings and require additional structural space outside of the actual fan strip. Since the structural space is limited in the area between the sliding headliner and the vehicle roof, the fan strip in accordance with the invention offers a space-saving solution. The influencing takes place in such a manner that an in particular laminar air current flowing through the ventilation opening and/or the air current duct is disturbed and converted into a turbulent flow so that flow noises and whistling noises caused by laminar air current can be avoided on account of the disturbing of the flow and a conversion into a turbulent flow. The arrangement of the device, which is advantageous for the structural space, can disturb the air current directly at the outlet from the ventilation opening, whereby a flow-disturbing retrograde effect into the flow duct of the ventilation opening can take place. Thus, every influencing of the air current is designated as flow-disturbing that can avoid distinctly perceptible flow noises and in particular whistling noises.

A vehicle roof that can be opened for the sliding headliner is any roof that allows an air current and in particular a flowing out of air from the vehicle interior to the outside. Such a roof contains, e.g., a sliding roof or sliding lifting roof in which a movably supported cover is arranged in a roof opening which cover can be shifted into an open position so that the air current can take place via the exposed roof opening. Such a sliding headliner with fan strip can also be built into a roof of a convertible in which a roof opening can be exposed when the convertible roof is closed (such a convertible vehicle is, e.g., the VW EOS). On the other hand, the sliding headliner can also be arranged under a permanent, transparent roof section in which an air current can flow through ventilation openings in the roof without having to expose a rather large roof opening for this.

Advantageous embodiments of the invention are indicated in the dependent claims.

A preferred embodiment provides that the device for influencing the air current has at least one disturbing edge or a disturbing body. The disturbing body generally has a shape that brings about a disturbance or turbulence of the air current flowing through, whereby sharp edges are especially effective.

The disturbing edge or disturbing body can be arranged in the direction of flow behind the ventilation opening or the air current duct and therefore in the air current flowing out. However, it is preferable if the device or the disturbing edge or the disturbing body extends into the cross section of the flow of the ventilation opening or of the air current duct and particular is also arranged in it. This achieves a compact structural unit.

The device for influencing the air current or the disturbing edge or the disturbing body can also be constructed as a continuous or interrupted strip that projects into the cross section of flow from a limitation such as, in particular, a wall, an edge crosspiece or a lamella that limits the ventilation opening or the air current duct.

If the strip projecting into the cross section of flow has an undercut to the construction part from which it projects such as, e.g., a limitation of the opening area or an edge crosspiece of the air current duct, the turbulence of the air current is additionally supported.

In a preferred embodiment the fan strip has at least one opening area in which at least one in particular slot-shaped ventilation opening or in particular a slot-shaped air current duct is contained. It is especially preferable if the fan strip contains six opening areas for the flowthrough and aeration.

The fan strip is advantageously produced from plastic such as, e.g., polycarbonate in an injection molding method and the disturbing body or the strip is formed on a separating position of the multipartite injection molding tool, in particular in the direction of mold release of a slide of an injection molding tool.

The fan strip can be an independent structural part that can be mounted in the sliding headliner or in an alternative embodiment it is integrally formed with the sliding headliner or with a part of the sliding headliner.

The problem is also solved by a sliding headliner with a fan strip in accordance with one of claims 1 to 8.

The invention is described in detail in the following using an exemplary embodiment of a fan strip, in accordance with the invention, of a sliding headliner with reference made to the drawings. In the drawings:

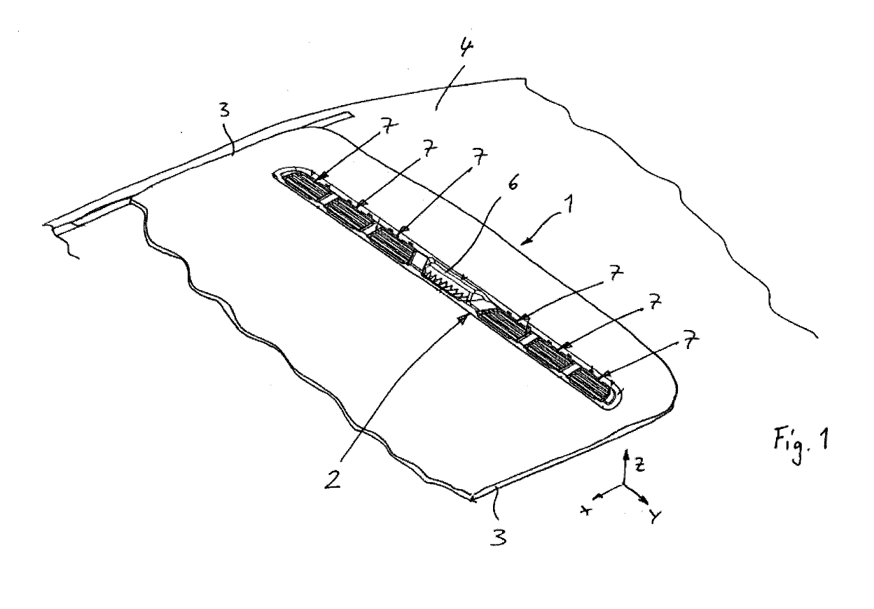

FIG. 1 shows an isometric view of the top of a sliding headliner with a fan strip arranged on it;

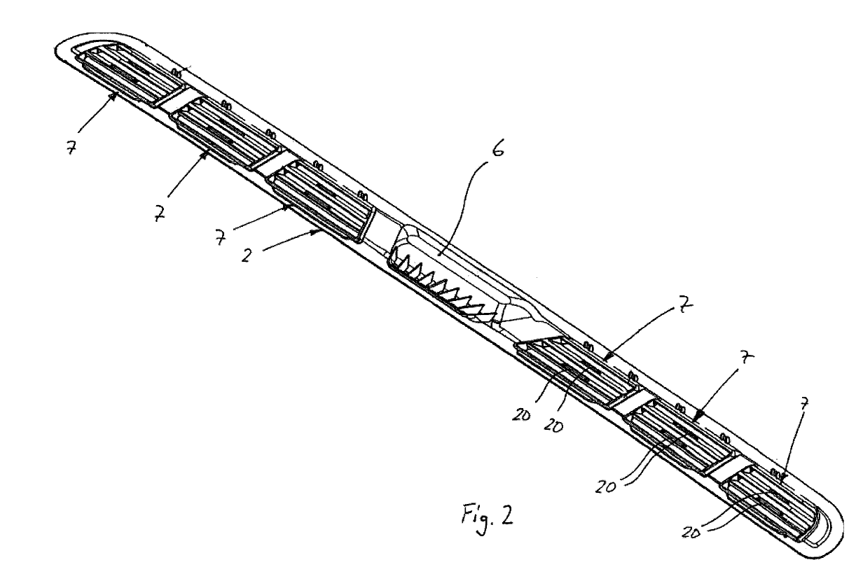

FIG. 2 shows an isometric top view of the fan strip of FIG. 1;

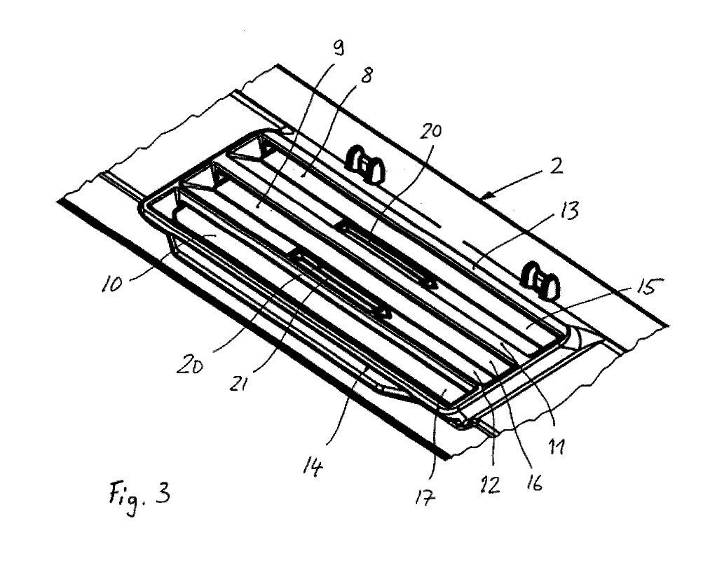

FIG. 3 shows an isometric top view of a section or opening area of the fan strip of FIG. 2; and

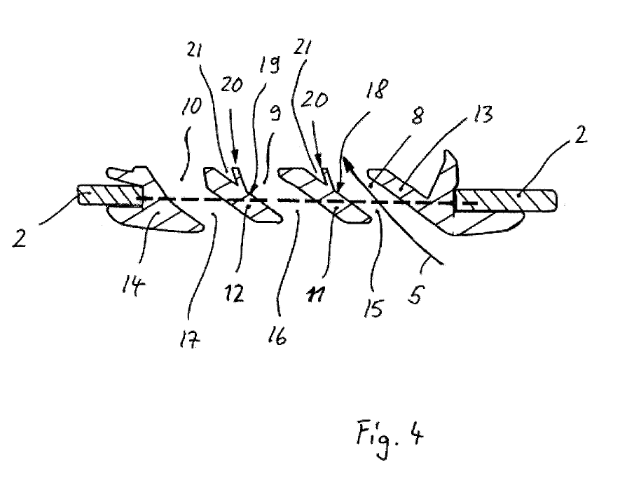

FIG. 4 shows the opening area of the fan strip in accordance with FIG. 3 in a longitudinal section.

A sliding headliner 1 of a motor vehicle contains a fan strip 2 arranged in a front area of the sliding headliner 1 in transverse alignment. The sliding headliner 1 is supported in such a manner that it can shift longitudinally on its side longitudinal edges 3 on guides arranged under the vehicle roof 4 (schematically shown) and can selectively expose or at least partially cover a roof opening of a vehicle roof that can be opened, e.g., of a sliding roof, sliding lifting roof or spoiler roof. Such a sliding headliner 1 is known, for example, from DE 35 27 839 C1. When the sliding headliner is closed and the roof opening is at least partially open at the same time an air flow 5 (see FIG. 4, air flow 5 shown by way of example and schematically) can flow down in particular during travel from the vehicle interior (underneath the sliding headliner 1 according to FIG. 1 or the fan strip 2 according to FIG. 4) through the fan strip 2 and the roof opening to the top of the vehicle roof 4.

The fan strip 2 in accordance with the invention contains a central grip trough 6 that has a downwardly open recess favorable for gripping so that the sliding headliner 1 underneath the vehicle roof 4 can be shifted manually and longitudinally into its desired position. Next to the side of the grip trough 6 the fan strip 2 contains several and in particular three opening areas 7 adjacent to each other for aerating and ventilating the vehicle interior. Each opening area 7 has slot-like aeration openings, whereby according to the exemplary embodiment (see in particular FIGS. 3 and 4) a front aeration opening 8, a middle aeration opening 9 and a rear aeration opening 10 (“front” and “rear” relative to the longitudinal direction of the vehicle or of the sliding headliner or the X direction in accordance with FIG. 1) that are separated from each other by two lamellas 11 and 12 conducting the particular air flow 5 and are limited in front and in the rear by edge crosspieces 13, 14 of the opening area 7. The opening area 7 can be constructed with the lamellas 11, 12 and the edge crosspieces 13, 14 as its own structural part that is inserted into corresponding recesses of the fan strip 2, or the lamellas and edge crosspieces are produced in one piece with the fan strip 2, e.g., in a plastic injection molding method (the cross-sectional view of FIG. 4 shows such an independent structural part that is inserted into a recess in the fan strip 2.

The lamellas 11, 12 and the edge crosspieces 13, 14 of the opening area 7 are formed in such a manner and arranged in such a position that each aeration opening 8, 9 and 10 contains an air current duct 15, 16 and 17 or is formed as such a one. The air current ducts 15, 16 and 17 are inclined by an angle of, for example, approximately 30° to 40° relative to the plane of the fan strip 2 or of the sliding headliner 1 so that the air currents 5 flow obliquely upward from below through the aeration openings 8, 9 and 10 and the air current ducts 15, 16 and 17 of the opening area 7.

A device for influencing the air flow 5 in the aeration openings 8 and 9 in the form of a strip 20 forming a disturbing body is arranged on the front surfaces 18 and 19 of the two lamellas 11 and 12, which surfaces limit the air current ducts 15 and 16. The strip 20 stands at an angle of approximately 35° away from the lamellas 11 and 12 and projects into the cross section of flow of the air current ducts 15 and 16. An undercut area 21 that forms an acute angle in cross section and is open to the top is formed between the strip 20 and the lamellas 11 and 12.

An air flow 5 that flows into the air current ducts 15 and 16 is disturbed in its laminar flow on the strips 20 that contain in particular a sharp disturbing edge in such a manner that it becomes turbulent already in the upper aeration openings 8 and 9 of the air current conduits 15 and 16. The air vortices produced thereby, the formation of which is furthered by the undercut areas 21 forming a flow depression, prevent a flow noise that would otherwise be produced by a uniform flow and that can occur as a whistling noise in particular at a rather high flow rate as well as at rather high travel speed and/or given the use of a rather strong blower.

The inclination of the strip 20 relative to the lamellas 11 and 12 and its cross-sectional shape is selected in such a manner that a disturbing edge with an effective flow is formed. The strip 20 can extend over the entire length (in the Y direction) of the air current ducts 15 and 16 and the aeration openings 8 and 9 or it is formed only in a middle section (see FIG. 3) of the length of the air current ducts 15 and 16. The strip 20 can be formed continuously or also with interruptions in this longitudinal direction. Such a disturbing body or a strip 20 can be arranged in each aeration opening 8, 9 and 10 and/or in each air current duct 15, 16 or 17 for the optimal effectiveness of the disturbance or turbulence of the entire air current through the opening area 7. A disturbing body can be advantageously provided in the air current duct 17 on the edge crosspiece 14 comparable to the arrangement on a lamella 11 or 12.

However, it can be sufficient according to the exemplary embodiment shown to provide such a strip 20 or a disturbing body only on the front and the middle air current ducts 15 and 16.

The strip 20 is an example of an effective disturbing body, however, even differently formed structural parts can also form such disturbing bodies as long as they bring about a sufficient turbulence of an air current that is otherwise largely laminar and in particular can form disturbing edges in the air current.

The strips 20 do not extend over the top of the open area 7 or of the lamellas 11 and 12 but could also be formed to project. The strip has a thickness of, e.g., 0.6 to 1.0 mm.

The strips 20 advantageously extend in the direction of mold release of a slide of an injection molding tool. Therefore, the fan strip 2 can be manufactured with a simpler tool and fewer manufacturing steps.

List of reference numerals

| | |
|---|---|
| 1 | Sliding headliner |
| 2 | Fan strip |
| 3 | Longitudinal edge |
| 4 | Vehicle roof |
| 5 | Air current |
| 6 | Grip trough |
| 7 | Opening area |
| 8 | Front aeration opening |
| 9 | Middle aeration opening |
| 10 | Rear aeration opening |
| 11 | Lamella |
| 12 | Lamella |
| 13 | Edge crosspiece |
| 14 | Edge crosspiece |
| 15 | Air current duct |
| 16 | Air current duct |
| 17 | Air current duct |
| 18 | Front surface |
| 19 | Front surface |
| 20 | Strip |
| 21 | Undercut area |

1. A fan strip of a sliding headliner of the vehicle roof that can be opened, the fan strip comprising: at least one ventilation opening that an air current can flow through, wherein the fan strip has a device for influencing the air current in the ventilation opening or in an air current duct associated with the ventilation opening.

2. The fan strip according to claim 1, wherein the device for influencing the air current has at least one disturbing edge or one disturbing body.

3. The fan strip according to claim 2, wherein the disturbing edge or the disturbing body extends into the cross section of flow of the ventilation opening or of the air current duct.

4. The fan strip according to claim 1, wherein the device for influencing the air current or the disturbing edge or the disturbing body is constructed as a continuous or interrupted strip that projects into the cross section of flow from a limitation, in particular an edge crosspiece or a lamella that limits the ventilation opening or the air current duct.

5. The fan strip according to claim 4, wherein the strip projecting into the cross section of flow has an undercut toward the limitation or to the edge crosspiece of the air current duct.

6. The fan strip according to claim 1, wherein the fan strip has at least one opening area in which at least one in particular slot-shaped ventilation opening or in particular a slot-shaped air current duct is contained.

7. The fan strip according to claim 1, wherein it is produced from plastic in an injection molding method and that the disturbing body or the strip is formed on a separating position of the multipartite injection molding tool, in particular in the direction of mold release of a slide of an injection molding tool.

8. The fan strip according to claim 1, wherein it is an independent structural part that can be mounted in the sliding headliner or that it is integrally formed with the sliding headliner or with a part of the sliding headliner.

9. A sliding headliner with a fan strip, wherein the fan strip is constructed in accordance with claim 1.
